(19) United States
(12) Patent Application Publication
(10) Pub. No.: US 2004/0082210 A1
(43) Pub. Date: Apr. 29, 2004

(54) Cartridge carrying multiple integrated circuit cards for removable insertion into portable and other electronic devices

(76) Inventors: Robert F. Wallace, Sunnyvale, CA (US); Eliyahou Harari, Los Gatos, CA (US)

Correspondence Address: PARSONS HSUE & DE RUNTZ LLP, 655 MONTGOMERY STREET, SUITE 1800, SAN FRANCISCO, CA, 94111, US

(21) Appl. No.: 10/282,476

(22) Filed: Oct. 28, 2002

(51) Int. Cl. H01R 13/62

(52) U.S. Cl. 439/152

(57) ABSTRACT

Two integrated circuit cards, such as those having semiconductor memory for storing user identification codes and/or data, are removably inserted into a receptacle of a host electronic device by means of a carrier or cartridge that holds them and causes electrical contacts of the cards to be properly aligned with mating device contacts within the receptacle. Multiple cards held in this manner take up little more space in the host electronic device than the single card currently used. This compact, easy to use connector mechanism is particularly advantageous for cellular telephones, palm organizers and computers, and other small hand held, battery powered, portable electronic devices but also finds application in other electronic equipment as well.

### FIELD OF THE INVENTION

This invention relates to the use of integrated circuit cards, and other types of electronic modules, that are removably connected with electronic devices by hand, and, more specifically, to connectors that hold the modules in electrical connection with the devices.

### BACKGROUND OF THE INVENTION

A card containing an integrated circuit chip is provided with certain types of electronic devices so that the card can be exchanged among two or more devices, or be used with a single device by allowing removal of the card from the device for configuration or programming of its integrated circuit. The integrated circuit cards are used to provide functionality to the electronic device, provide memory capacity for the device, and the like. A mechanism that is part of the electronic device holds the card with mating electrical contacts held against each other. Although not limited to use with small hand held portable electronic devices that are battery powered, the small size of such cards and low power consumption have resulted in them being commonly used with this class of devices. Examples of such devices include cellular telephones, other types of telephones and radio communication devices, and palm held organizers and computers.

Electronic devices have recently been developed which use two such cards having different configurations and performing different functions. Therefore, it is a primary object of the present invention to provide a technique and system for removably connecting two or more small circuit cards to the device but while consuming a minimum amount of space within the device.

It is another object of the present invention to provide a connector mechanism that easily and assuredly causes each card to become electrically connected with the host electronic device when positioned in the device.

### SUMMARY OF THE INVENTION

These and other objects are accomplished by the present invention, wherein, briefly and generally, a cartridge that is removably insertible into a slot of a mating receptacle in the electronic device carries two or more circuit cards that are easily placed into and removed from the cartridge by hand. In a two card embodiment, the cards are placed on opposite sides of the cartridge with their surfaces containing the electrical contacts facing outward of the cartridge. The electronic device receptacle includes parallel surfaces forming a slot between them, in which the cartridge, with cards inserted, is positioned. Each of these surfaces contains contacts arranged in a pattern matching that of the contacts of one of the cards. In a specific embodiment, these receptacle contacts are resiliently biased away from their surfaces so that they make firm contact with the card contacts when the cartridge is inserted into the receptacle slot, thereby holding the cartridge in the slot as well as establishing electrical contact between the host device electronics and the cards.

Additional objects, advantages and features of the present invention will become apparent from the following description of its preferred embodiments and comparison with the prior art, which description should be taken in conjunction with the accompanying drawings.

### BRIEF DESCRIPTION OF THE DRAWINGS

FIG. 1 is a perspective view of a hand held telephone having a receptacle with a circuit card cartridge inserted therein;

FIG. 2 is a perspective view of the telephone of FIG. 1 with the cartridge removed from the telephone receptacle;

FIG. 3 is a perspective view of one side of the cartridge of FIG. 2 with its circuit card removed;

FIG. 4 is the perspective view of FIG. 3 with its circuit card fully inserted into the cartridge;

FIG. 5 is a perspective view of the opposite side of the cartridge of FIG. 2 with its circuit card partially removed;

FIG. 6 is the perspective view of FIG. 5 with its circuit card fully inserted into the cartridge;

FIG. 7 is a perspective view of the cartridge of FIGS. 3-6 carrying circuit cards, and a mating receptacle within the telephone of FIGS. 1 and 2;

FIG. 8 is a side sectional view of FIG. 7, taken at section 8-8 thereof; and

FIG. 9 is a modification of the views of FIGS. 7 and 8, where the cartridge is inserted into the receptacle within the telephone of FIGS. 1 and 2.

### DESCRIPTION OF THE PREFERRED EMBODIMENTS

A very small card containing memory on an integrated circuit chip is commonly used with cellular telephones for storing data of the user of the telephone, including security and billing codes, and the like. It is termed a Subscriber Identity Module (SIM). With increased capabilities being provided in portable electronic devices, use of a second card has been proposed. In the case of a cellular telephone, a non-volatile memory card using flash electrically erasable and programmable read-only-memory (EEPROM) can store the entire telephone book of a number of cities, serve to store voice mail messages, and provide other memory intensive functions. Other more recent standards for such cards include a Multi-Media Card (MMC) and Secure Digital (SD) card. Use of a second card allows use of the SIM card to continue without significant change. The techniques of the present invention provide for connecting both the mass memory (MMC or SD) and SIM cards to a host electronic device without becoming excessively complicated or requiring much more space. Alternatively, other types of data storage modules, such as those utilizing dynamic random access memory (DRAM) or read-only-memory (ROM), may be connected in this manner.

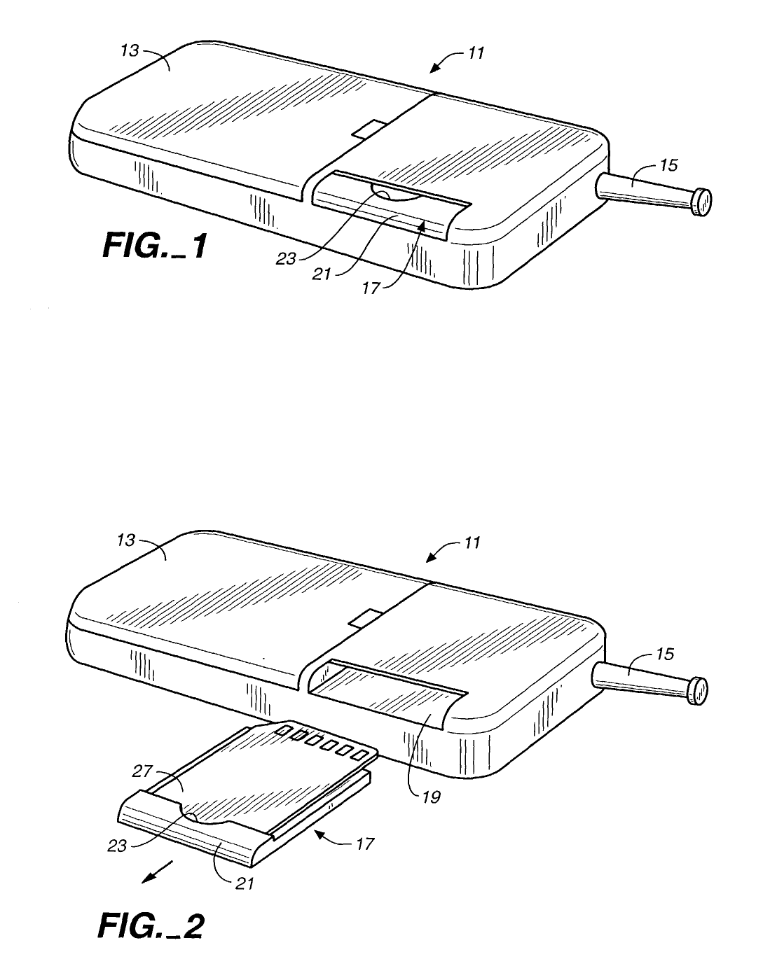

Referring initially to FIGS. 1 and 2, the improved connector of the present invention is provided in a cellular telephone 11 but may be used with advantage in a wide variety of host electronic devices, particularly those that are portable, hand held, and battery operated. The device 11 includes a usual removable battery 13 and an antenna 15. An integrated circuit card or module carrier or cartridge 17 is inserted into and removed from an opening 19 of the outer case of the device 11 that connects to a receptacle within the case into which the cartridge 17 is inserted. The cartridge 17 is much thinner than it is long or wide. The receptacle within the device 11 is complementarily shaped to receive the cartridge when carrying two cards. The receptacle is preferably oriented to hold the cartridge with the cards it carries being parallel to the outer case of the device. This minimizes the effect upon the overall compact design of the device 11 of including the receptacle within it. The cartridge 17 has a length and width only slightly larger than that of the largest of the two cards it is designed to carry. The thickness of the cartridge is that of the two cards plus a small additional thickness of a card supporting structure. As a result, little additional space is taken by the cartridge to provide a convenient mechanism for inserting and removing two integrated circuit cards.

One end 21 of the cartridge is given the shape of the device case, so that the outer surface of the case and cartridge is continuous when the cartridge 21 is inserted into the device 11, as shown in FIG. 1. However, the surface 21 of the cartridge 17 is provided with an indentation 23 for the user to insert an end of a finger to slide the cartridge 17 out of the device 11. The cartridge 17 is made to be slidable into and out of the device 11 by hand and retained in the device by frictional forces of electrical contacts, described below, pushing against the cards from opposite sides of the cartridge.

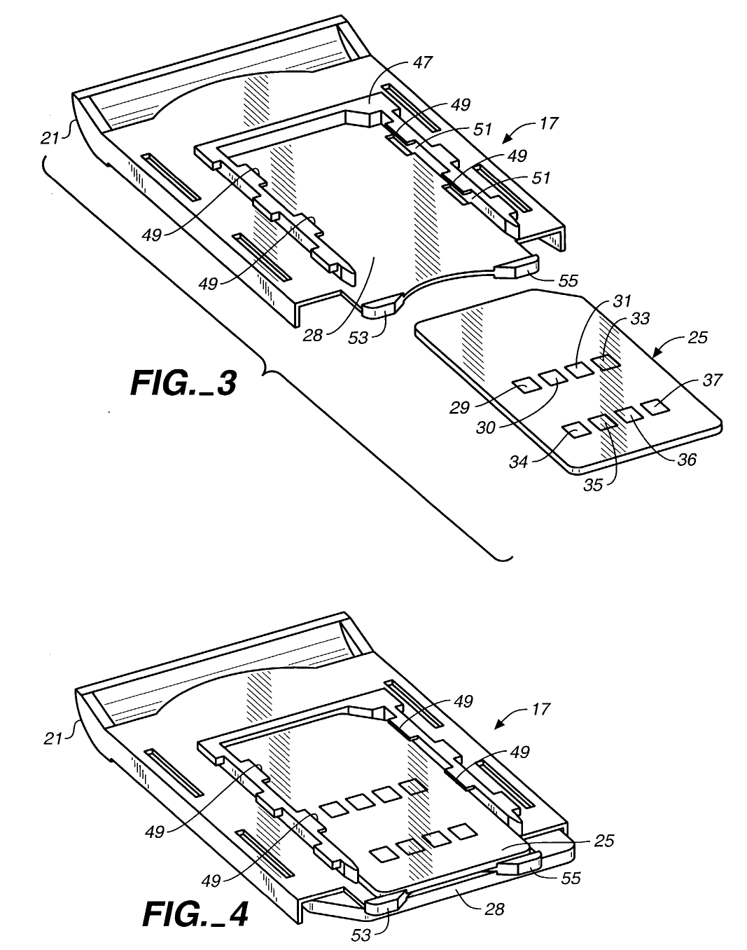

FIGS. 3-6 best show the structure of the cartridge 17 and its holding of a SIM 25 and a MMC 27 against opposite sides of a wall 28. The SIM 25 has two rows of metallic contacts 29-37 extending across one of its opposing sides. The MMC 27 has one row of contacts 39-45 extending across one of its opposing sides adjacent an edge of the card. The width and length of the cartridge wall 28 are only slightly larger than that of the MMC 27, thus requiring little extra area for the electronic device 11 to accommodate the cartridge. The MMC 27 is larger in its width and length than the SIM 25. The thickness of each card is about one millimeter or less.

On one side of the wall 28 is a ridge (FIGS. 3 and 4) positioned to surround the card 25 on three sides, the fourth side opposite from the end 21 being left open for insertion and removal of the card. The ridge 47 includes ledges 49 having bottom surfaces that are parallel with that side of the wall 28, to form a vertical slot 51 in the ridge 47 that is slightly higher than the thickness of the card 25. The card 25 is then easily slidable into and out of the slot through the open side of the ridge 47. The card 25 is retained in the slot 51 by protrusions 53 and 55 that extend above the wall surface for a distance less than the thickness of the card 25. The slot 51 is made sufficiently higher than the thickness of the card 25 to allow the card to be slid into the slot over the tops of the protrusions 53 and 54. Displacement of the ledges 49 a distance from the protrusions 53 and 55 also allows the card's limited flexibility to be used when the card 25 is slid into the slot over the protrusions 53 and 55. Once in place, as shown in FIG. 4, the card 25 is retained in the cartridge by the ridge 47 on three sides, the protrusions 53 and 55 on the fourth side and the slot 51. The slot 51 also retains the card 25 from movement away from the wall 28.

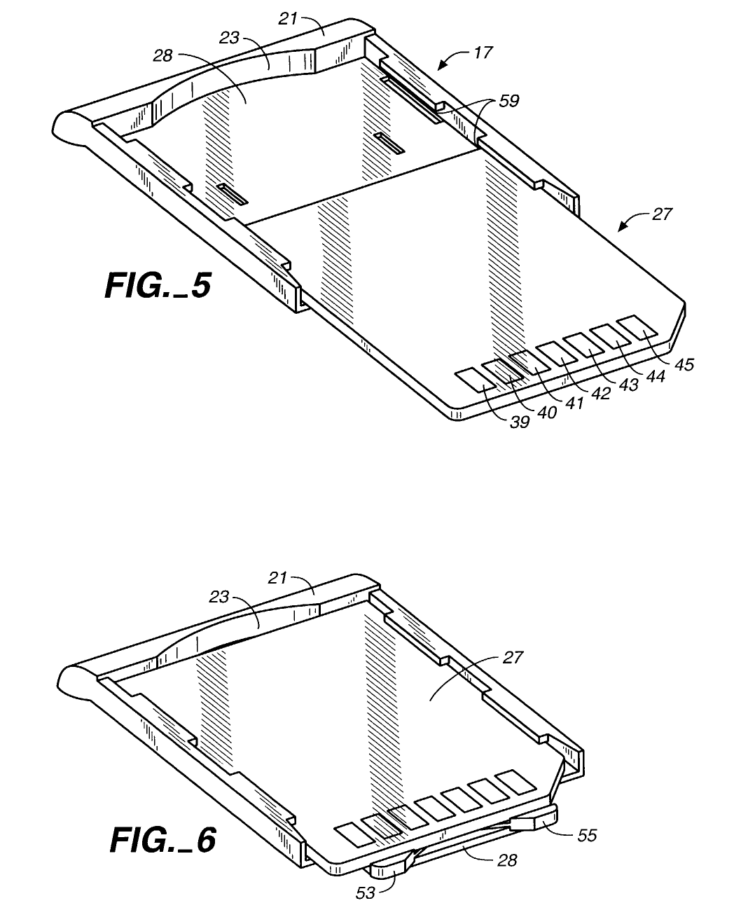

On an opposite side of the wall 28, a duplicate of the same elements described above to hold the card 25 are provided to hold the card 27 but with different dimensions because of the different sizes of the two cards. As can be seen from FIGS. 5 and 6, a card receiving slot 59 is formed along opposite sides of the wall 28. The card 27 is retained in the cartridge 17 when slid into the slot 59 over the protrusions 53 and 55.

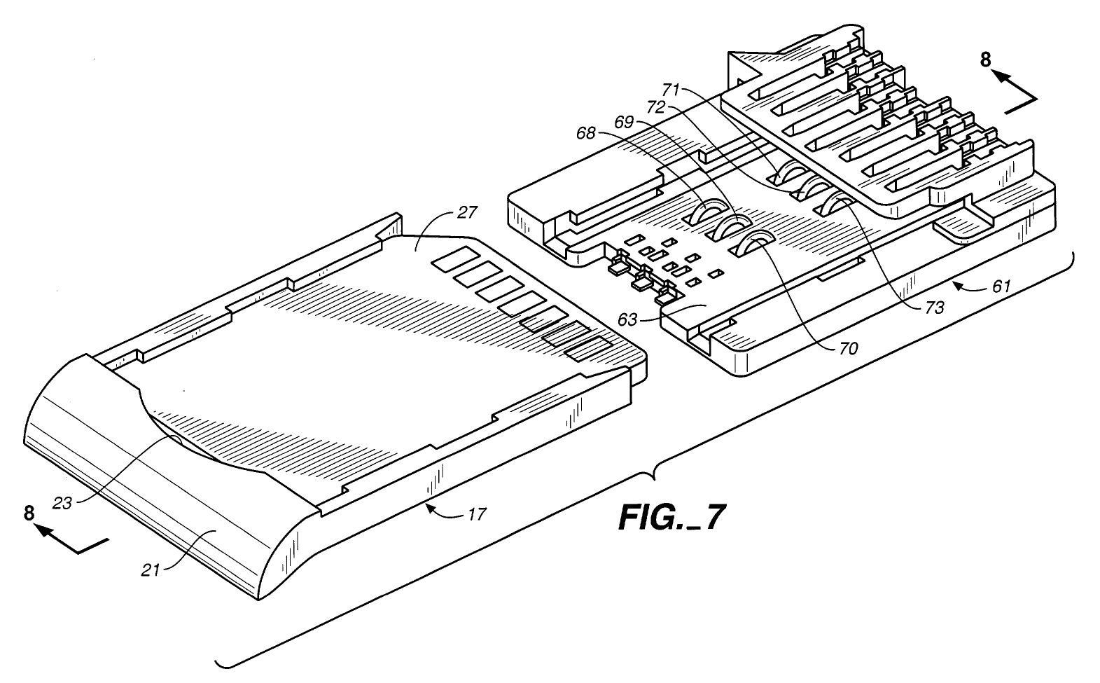

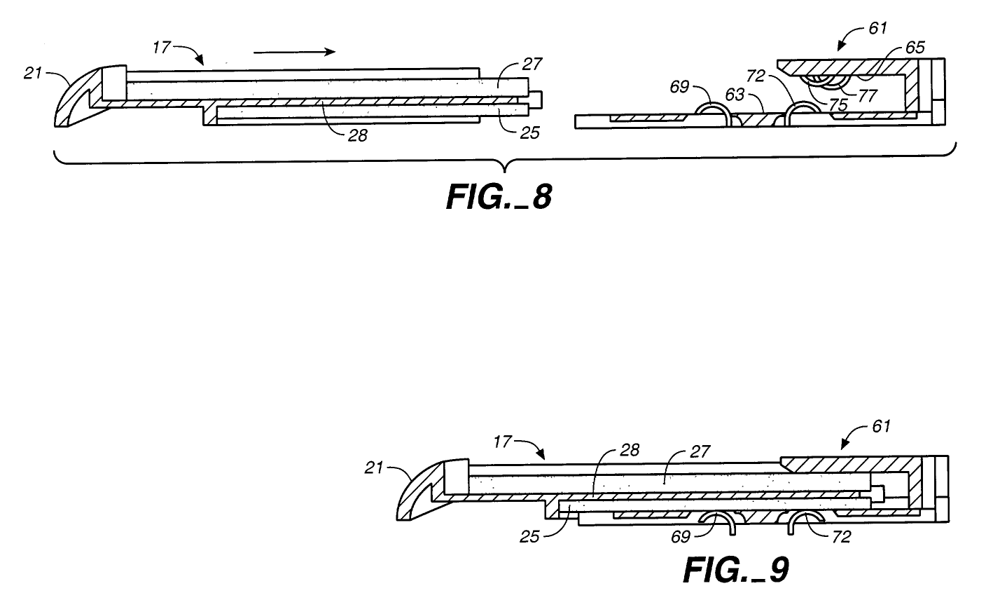

The manner in which the cartridge 17 and the two cards it is carrying cooperate with a mating receptacle 61 within the electronic device 11 is shown in FIGS. 7-9. Two parallel surfaces 63 and 65 of the receptacle 61 form a slot into which the loaded cartridge 17 is inserted. The surfaces 63 and 65 are separated sufficiently to allow easy insertion and removal by hand of the loaded cartridge. The loaded cartridge 17 is retained within the receptacle 61 by the resilient force of the receptacle's electrical contacts pushing against the mating surface contacts of the cards from opposite sides of the cartridge 17. Of course, some other mechanism can additionally be added or substituted to more positively retain the cartridge 17 within the receptacle 61.

The surface 63 of the receptacle 61 contains contacts 68-73 arranged in the same pattern thereacross as the contacts 29-31 and 34-36 of the SIM 25 (FIG. 3). Contacts are not provided in the receptacle for the SIM contacts 33 and 37 but can be if desired. Each of the contacts 68-73 is made of resilient metal and held within a slot in the surface 63. As can be seen from FIG. 9, these contacts are pushed against their resiliency a distance into their respective slots when the card 25 is positioned against the surface 63. Electrical connection is then made between the card 25 and electronic circuits within the host device 11.

Similarly, the surface 65 contains slots in which seven spring loaded contacts are held, such as contacts 75 and 77, in a pattern across that surface that matches that of the contacts 39-45 of the MMC 27. Therefore, when the cartridge 17 is inserted into the receptacle 61, each of these contacts firmly presses against its counterpart contact on the card 27. This establishes electrical connection between the card 27 and electronic circuits within the host device 11.

Although the various aspects of the present invention have been described with respect to the preferred embodiments thereof, it will be understood that the invention is entitled to protection within the full scope of the appended claims.

It is claimed:

1. A connector of first and second integrated circuit cards with a host electronic device, wherein each of the first and second cards has a plurality of electrical contacts positioned across one surface thereof in respective first and second patterns, comprising:
a cartridge into which the first and second cards are removably insertable on opposite sides thereof with the electrical contacts of the cards facing away from the cartridge,
a receptacle in the electronic device in which said cartridge may be inserted and removed through an opening of a case of the host device when carrying the first and second cards, said receptacle including:
a first surface containing a third set of a plurality of electrical contacts positioned thereacross in a third pattern that matches said first pattern of electrical contacts of the first card, wherein said third set of contacts are resiliently urged away from the first surface,
a second surface containing a fourth set of a plurality of electrical contacts positioned thereacross in a fourth pattern that matches said second pattern of electrical contacts of the second card, wherein said fourth set of contacts are resiliently urged away from the second surface, and
said first and second surfaces having their contacts facing each other across a slot with a dimension between the first and second surfaces such that the cartridge carrying said first and second cards is positionable therebetween with their card contacts pushing against the resilience of respective contacts of the first and second surfaces, thereby to establish an electrical connection between mating card and surface contacts.

2. The connector of claim 1, wherein the cartridge includes a wall having slots formed on either side thereof in which the first and second cards are respectively slidable along the wall when inserting or removing the cards.

3. The connector of claim 2, wherein the slots formed on either side of the cartridge wall are shaped to receive the first and second cards of different sizes.

4. The connector of claim 1, wherein the contacts of the third set are positioned within slots of the first surface, and the contacts of the fourth set are positioned within slots of the second surface.

5. The connector of claim 1, wherein the receptacle is positioned within a battery powered portable host electronic device.

6. The connector of claim 1, wherein at least one of the first and second cards contains a flash EEPROM system.

7. A connector of first and second integrated circuit cards with a hand held portable host electronic device, wherein each of the first and second cards has a plurality of electrical contacts positioned across one surface thereof in respective first and second patterns, comprising:
a cartridge into which the first and second cards are removably insertible on opposite sides thereof to be held thereby with their electrical contacts exposed in a direction facing away from the cartridge, and
a receptacle within the host electronic device in which an edge of said cartridge is insertible and removed by hand when carrying the first and second cards, said receptacle including an internal slot formed of opposing surfaces having electrical contacts of the host electronic device arranged in said first and second patterns, whereby electrical contact is established between contacts of the first and second cards and those of the host electronic device when the cartridge is inserted into the receptacle through the opening.

8. The connector of claim 7, wherein the host electronic device is a cellular telephone.
